(19) United States
(12) Patent Application Publication
(10) Pub. No.: US 2012/0245241 A1
(43) Pub. Date: Sep. 27, 2012

(54) POLYURETHANE PREPOLYMERS

(75) Inventors: Evelyn Peiffer, Leverkusen (DE); Mathias Matner, Neuss (DE)

(73) Assignee: Bayer Intellectual Property GmbH, Monheim (DE)

(21) Appl. No.: 13/514,754

(22) PCT Filed: Dec. 6, 2010
(86) PCT No.: PCT/EP2010/068981

§ 371 Date: Jun. 8, 2012

(30) Foreign Application Priority Data
Dec. 9, 2009 (DE) 10 2009 057 597.7

(51) Int. Cl. C08G 71/04; C09J 175/04; C09D 175/04

(52) U.S. Cl. 521/154; 528/28; 524/590

(57) ABSTRACT

The invention relates to polyurethane prepolymers, to a method for the production thereof, and to the use thereof as binding agents for adhesives, coatings, or foams.

The present invention relates to polyurethane prepolymers, to a process for their preparation, and to their use as binders for adhesives, coatings or foams.

Alkoxysilane-functional polyurethanes which crosslink via a silane polycondensation have been known for a long time. An overview article on this subject is to be found, for example, in “Adhesives Age” 4/1995, page 30 ff (authors: Ta-Min Feng, B. A. Waldmann). Such alkoxysilane-terminated, moisture-curing one-component polyurethanes are increasingly being used as flexible coating, sealing and adhesive compositions in construction and in the automotive industry.

Such alkoxysilane-functional polyurethanes can be prepared according to U.S. Pat. No. 3,627,722 or DE-A 1 745 526 by, for example, reacting polyether polyols with an excess of polyisocyanate to give an NCO-containing prepolymer, which is then in turn reacted further with an amino-functional alkoxysilane.

Publications EP-A 0 397 036, DE-A 19 908 562 (corresponding to EP-A 1 093 482) and US-A 2002/0100550 describe further different methods of preparing alkoxysilane-terminated polymers. According to those specifications, high molecular weight polyethers having an average molecular weight of 4000 g/mol or greater are used in each case.

Application EP-A 0 070 475 describes the preparation and use of alkoxysilane-terminated polymers starting from hydrogen acidic prepolymers by termination with NCO-functional alkoxysilanes. Polyols having a molar weight of from 500 to 6000 g/mol are used for the prepolymer synthesis. The polymers described therein are used as binders in sealing material formulations, that is to say flexible systems.

An analogous process is described in application DE-A 10 2007 058 344.

All these alkoxysilane-terminated systems form, after curing, flexible polymers having relatively low strength and high breaking elongation. DE-A 1 745 526 describes tensile strengths in the range from 3.36 kg/cm² to 28.7 kg/cm² for polyoxypropylene glycol-based polymers. High strengths that are adequate for structural bonding are achieved only with crystallising polycaprolactones.

However, such systems are very highly viscous or solid at room temperature and can therefore only be processed in the warm state.

Accordingly, the field of use of the above-mentioned applications is limited on the one hand to sealing materials and flexible adhesives and on the other hand to highly viscous or solid systems which can only be processed in the warm state.

The object underlying the present invention was, therefore, to provide alkoxysilane-terminated polyurethanes that are liquid at room temperature and achieve a high cohesive strength after curing, so that they can be used to formulate adhesives permitting structural bonding.

It has now been found that such alkoxysilane-terminated polyurethanes can be prepared by first producing a prepolymer containing isocyanate-reactive hydrogen from a polyisocyanate and a mixture of compounds having groups reactive towards isocyanates. The mixture of compounds having groups reactive towards isocyanates thereby contains low molecular weight, multifunctional isocyanate-reactive compounds having a molecular weight ≦500 g/mol in an amount of from 1 to 40 wt. %. Finally, the resulting prepolymer containing isocyanate-reactive hydrogen is modified with an isocyanate-functional alkoxysilane.

The invention accordingly provides polymers modified with alkoxysilane groups, obtainable by reacting
a) a prepolymer containing isocyanate-reactive hydrogen, which contains structural units of the general formula (I)

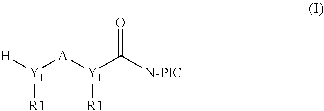

wherein
PIC represents a radical of a polyisocyanate (B) reduced by the isocyanate groups,
Y¹ represents nitrogen, oxygen or sulfur,
R¹ represents either a free electron pair or hydrogen or any desired organic radical,
A represents a radical, reduced by the isocyanate-reactive groups, of an isocyanate-reactive polymer and low molecular weight, multifunctional isocyanate-reactive compounds, which is composed of low molecular weight, multifunctional isocyanate-reactive compounds (A1), which are linked together in any desired sequence, that is to say blockwise, alternately or randomly, via the structural element of the formula

—Y²—(C═O)—NH—PIC—NH—(C═O)—Y¹(R¹)—,
wherein Y¹ and Y² independently of one another represent nitrogen, oxygen or sulfur, derived from the polyisocyanates B, and polyether polyols, polyester polyols, polycarbonate polyols or polytetrahydrofuran polyols (A2), wherein all or some of the terminal groups of those substructures can also be the corresponding thio compounds or amine derivatives, wherein
from 1 to 40 wt. % are substructures A1 having a mean molecular weight (Mn) of less than 500 g/mol and
from 60 to 99 wt. % are substructures A2 having a mean molecular weight (Mn) of more than 500 g/mol,
and wherein A overall has a mean functionality of from 2 to 6,
with
b) an isocyanate-functional alkoxysilane compound (component C) of the general formula (II):

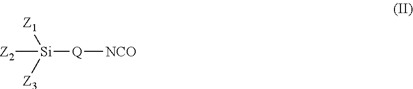

wherein
Z¹, Z² and Z³ are identical or different C₁-C₈-alkoxy or C₁-C₈-alkyl radicals, which can also be bridged, but wherein at least one C₁-C₈-alkoxy radical must be present on each Si atom,
Q is a difunctional linear or branched organic radical, preferably an alkylene radical having from 1 to 8 carbon atoms.

The reaction of a) with b) can take place in a ratio of from 0.8:1.0 to 1.5:1.0 (NCO:Y—H).

The compounds according to the invention are non-crystallising substances that are liquid at room temperature and have a number-average molecular weight of less than 5000 g/mol, preferably less than 4000 g/mol, and a viscosity of less than 700 Pas at 23° C., preferably less than 500 Pas at 23° C.

The mixture of isocyanate-reactive compounds (component A) consists of from 1 to 40% of a low molecular weight, multifunctional isocyanate-reactive compound (A1) having from 2 to 6 isocyanate-reactive groups and a number-average molecular weight of less than 500 g/mol, and from 60 to 99% of an isocyanate-reactive compound (A2) having from 2 to 6 isocyanate-reactive groups and a number-average molecular weight of more than 500 g/mol, wherein both A1 and A2 can each consist of combinations of compounds having isocyanate-reactive groups, provided those compounds fall within the above-described limits in respect of the molecular weight.

There can be used as component A any compounds known to the person skilled in the art that contain isocyanate-reactive groups and have a functionality, in the mean, of at least 2. These can be for A1, for example, low molecular weight, multifunctional isocyanate-reactive compounds such as aliphatic polyols or polyamines, aromatic polyols or polyamines, and for A2, for example, higher molecular weight isocyanate-reactive compounds such as polyether polyols, polycarbonate polyols, polyester polyols as well as polythioether polyols. Preferably, such isocyanate-reactive compounds have a mean functionality of from 2 to 6, preferably from 2 to 3.5 and particularly preferably from 2 to 3.

There are preferably used in component A1 polyhydric, preferably dihydric or trihydric, alcohols, such as, for example, ethylene glycol, diethylene glycol, triethylene glycol, tetraethylene glycol, 1,2-propanediol, 1,3/1,4-butanediol, 1,3-/1,6-hexanediol, 1,8-octanediol, neopentyl glycol, 1,4-bis(hydroxymethyl)cyclohexane, bis(hydroxymethyl)tricyclo-[5.2.1.02.6]decane or 1,4-bis(2-hydroxyethoxy)benzene, 2-methyl-1,3-propanediol, 2,2,4-trimethylpentane-1,3-diol, 2-ethyl-1,3-hexanediol, dipropylene glycol, polypropylene glycols, dibutylene glycol, polybutylene glycols, 1,4-phenoldimethanol, bisphenol A, tetrabromobisphenol A, glycerol, trimethylolpropane, 1,2,6-hexanetriol, 1,2,4-butanetriol, pentaerythritol, quinitol, mannitol, sorbitol, methyl glycoside and 4,3,6-dianhydrohexite.

Suitable di- or tri-amines can be aliphatic amines, for example ethylenediamine, 1,2-propylenediamine, 1,3-propylenediamine, 1,4-butanediamine, neopentanediamine, 1,5-diamino-2-methylpentane (Dytek® A, DuPont), 2-butyl-2-ethyl-1,5-pentanediamine, 1,6-hexamethylenediamine, 2,5-diamino-2,5-dimethylhexane, 2,2,4- and/or 2,4,4-trimethyl-1,6-diaminohexane, 1,8-diaminooctane, 1,11-diaminoundecane, 1,12-diaminododecane, 4-aminomethyl-1,8-octanediamine(triaminononane), diethylenetriamine, triethylenetetramine, cycloaliphatic amines, such as, for example, 1-amino-3,3,5-trimethyl-5-aminomethyl-cyclohexane (isophoronediamine, IPDA), TCD-diamine, 1,4-cyclohexanediamine, 2,4- and/or 2,6-hexahydrotoluoylenediamine (H₆TDA), isopropyl-2,4-diaminocyclohexane and/or isopropyl-2,6-diaminocyclohexane, tricyclodecanebis(methylamine), 1,3-bis-(aminomethyl)-cyclohexane, 2,4′- and/or 4,4′-diaminodicyclohexylmethane (PACM 20), 3,3′-dimethyl-4,4′-diamino-dicyclohexylmethane (Laromin® C 260, BASF AG, DE), the isomeric diaminodicyclohexylmethanes containing a methyl group as substituent on the ring (such as, for example, C-monomethyl-diaminodicyclohexylmethanes), 3 (4)-aminomethyl-1-methylcyclohexylamine (AMCA), as well as araliphatic di- or tri-amines, such as, for example, 1,3-diaminobenzene, 1,4-diaminobenzene, 2,4- and/or 2,6-diaminotoluene (TDA), 1,3-bis-(aminomethyl)-benzene, 3,5-diethyltoluene-2,4-diamine, m-xylylenediamine, 4,6-dimethyl-1,3-benzenedimethanamine, 4,4′- and/or 2,4′- and/or 2,2′-methylenebisbenzeneamine (MDA), or amines containing heteroatoms, dimer fatty acid diamine, bis-(3-aminopropyl)-methylamine, 4,9-dioxadodecane-1,12-diamine or 4,7,10-trioxamidecane-1,13-diamine.

Polyether polyols are preferably used in component A2. These are obtainable in a manner known per se by alkoxylation of suitable starter molecules with base catalysis or using double metal cyanide compounds (DMC compounds). Suitable starter molecules for the preparation of polyether polyols are molecules having at least 2 elemental hydrogen bonds reactive towards epoxides, or arbitrary mixtures of such starter molecules.

Particularly suitable polyether polyols are those of the above-mentioned type having a content of unsaturated end groups of less than or equal to 0.02 milliequivalents per gram of polyol (meq/g), preferably less than or equal to 0.015 meq/g, particularly preferably less than or equal to 0.01 meq/g (method of determination ASTM D2849-69).

This is described, for example, in US-A 5 158 922 (e.g. Example 30) and EP-A 0 654 302 (p. 5, l. 26 to p. 6, l. 32).

Suitable starter molecules for the preparation of polyether polyols are, for example, simple, low molecular weight polyols, water, ethylene glycol, 1,2-propanediol, 2,2-bis(4-hydroxyphenyl)propane, 1,3-propylene glycol and 1,4-butanediol, 1,6-hexanediol, neopentyl glycol, 2-ethyl-1,3-hexanediol, trimethylolpropane, glycerol, pentaerythritol, sorbitol, organic polyamines having at least two N—H bonds, such as, for example, triethanolamine, ammonia, methylamine or ethylenediamine, or arbitrary mixtures of such starter molecules. Alkylene oxides suitable for the alkoxylation are in particular ethylene oxide and/or propylene oxide, which can be used in the alkoxylation in any desired sequence or also in admixture.

It is also possible to use polyether polyol mixtures which contain at least one polyol having at least one tertiary amino group. Such polyether polyols containing tertiary amino groups can be prepared by alkoxylation of starter molecules or mixtures of starter molecules at least containing a starter molecule having at least 2 elemental hydrogen bonds reactive towards epoxides, of which at least one is an NH bond, or low molecular weight polyol compounds which carry tertiary amino groups. Examples of suitable starter molecules are ammonia, methylamine, ethylamine, n-propylamine, isopropylamine, ethanolamine, diethanolamine, triethanolamine, ethylenediamine, ethylenetriamine, triethanolamine, N-methyl-diethanolamine, ethylenediamine, N,N′-dimethyl-ethylenediamine, tetramethylenediamine, hexamethylenediamine, 2,4-toluoylene-diamine, 2,6-toluoylenediamine, aniline, diphenylmethane-2,2′-diamine, diphenylmethane-2,4′-diamine, diphenylmethane-4,4′-diamine, 1-aminomethyl-3-amino-1,5,5-trimethylcyclohexane (isophoronediamine), dicyclohexylmethane-4,4′-diamine, xylylenediamine and polyoxyalkylene-amines.

It is also possible to use polyether polyols in which organic fillers are dispersed, such as, for example, addition products of toluoylene diisocyanate with hydrazine hydrate or copolymers of styrene and acrylonitrile.

The polytetramethylene ether glycols having molecular weights of from 400 g/mol to 4000 g/mol, obtainable by polymerisation of tetrahydrofuran, as well as hydroxyl-group-containing polybutadienes can also be used.

Hydroxyl polycarbonates are to be understood as being reaction products of glycols of the type ethylene glycol, diethylene glycol, 1,2-propylene glycol, 1,4-butanediol, neopentyl glycol or 1,6-hexanediol and/or triols, such as, for example, glycerol, trimethylolpropane, pentaerythritol or sorbitol, with diphenyl carbonate and/or dimethyl carbonate. The reaction is a condensation reaction in which phenol and/or methanol are cleaved. There are obtained, depending on the composition, liquid to wax-like, amorphous types having Tg values of >−40° C. or crystalline polycarbonate polyols having melting ranges from 40 to 90° C. The molecular weight range is from 200 g/mol to 10,000 g/mol. The molecular weight range from 400 g/mol to 5000 g/mol is preferred. The molecular weight range from 500 g/mol to 3000 g/mol is particularly preferred.

Hydroxyl polyesters are to be understood as being reaction products of aliphatic, cycloaliphatic, aromatic and/or heterocyclic polybasic, but preferably dibasic, carboxylic acids, such as, for example, adipic acid, azelaic acid, sebacic and/or dodecanedioic acid, phthalic acid, isophthalic acid, succinic acid, suberic acid, trimellitic acid, phthalic anhydride, tetrahydrophthalic anhydride, glutaric anhydride, tetrachlorophthalic anhydride, endomethylenetetrahydrophthalic anhydride, maleic anhydride, maleic acid, fumaric acid, dimer and trimer fatty acids such as oleic acid, optionally in admixture with monomeric fatty acids, terephthalic acid dimethyl ester or terephthalic acid bis-glycol ester, ortho-, iso- or terephthalic acid, with polyhydric, preferably dihydric or trihydric, alcohols, such as, for example, ethylene glycol, diethylene glycol, triethylene glycol, tetraethylene glycol, 1,2-/1,3-propanediol and 1,4/1,3-butanediol, 1,6-hexanediol, 1,8-octanediol, neopentyl glycol, 1,4-bis(hydroxymethyl)cyclohexane, bis(hydroxymethyl)tricyclo[5.2.1.0^{2.6}]decane or 1,4-bis(2-hydroxyethoxy)benzene, 2-methyl-1,3-propanediol, 2,2,4-trimethylpentanediol, 2-ethyl-1,3-hexanediol, dipropylene glycol, polypropylene glycols, dibutylene glycol, polybutylene glycols, 1,4-phenoldimethanol, bisphenol A, tetrabromobisphenol A, glycerol, trimethylolpropane, 1,2,6-hexanetriol, 1,2,4-butanetriol, pentaerythritol, quinitol, mannitol, sorbitol, methyl glycoside or 4,3,6-dianhydrohexite. Instead of the free polycarboxylic acids, the corresponding polycarboxylic anhydrides or corresponding polycarboxylic acid esters of lower alcohols, or mixtures thereof, can also be used concomitantly to prepare the polyester.

The reaction is a normal melt condensation, as is described in Ullmanns Enzyklopädie der technischen Chemie, “Polyester”, 4th Edition, Verlag Chemie, Weinheim, 1980. There are obtained, depending on the composition, liquid, amorphous types having Tg values of >20° C. or crystalline polyester polyols having melting ranges from 40 to 90° C. The polyester polyols which can be used according to the invention have number-average molecular weights of from 500 g/mol to 2500 g/mol, preferably from 800 g/mol to 2000 g/mol.

Particular mention may be made here also of the products which are derived from reaction products of glycerol and hydroxyl fatty acids, in particular castor oil and its derivatives, such as, for example, monodehydrated castor oil.

Corresponding hydroxyl-group-terminated poly-ε-caprolactones can also be used.

In addition to the polyhydroxy compounds, polyether amines can also be used proportionately in component A. The same limits as already indicated for the polyether polyols apply in respect of the preferred molecular weights and composition of the mixture.

The above-mentioned isocyanate-reactive compounds can be reacted with any polyisocyanates, aromatic as well as aliphatic, before the actual prepolymerisation to give urethane-modified hydroxyl compounds.

There come into consideration as component B aromatic, aliphatic and cycloaliphatic diisocyanates as well as mixtures thereof. Suitable diisocyanates are compounds of the formula PIC(NCO)₂ having a mean molecular weight below 400 g/mol, wherein PIC denotes an aromatic C₆-C₁₅-hydrocarbon radical, an aliphatic C₄-C₁₂-hydrocarbon radical or a cycloaliphatic C₆-C₁₅-hydrocarbon radical, for example diisocyanates from the group butane diisocyanate, pentane diisocyanate, hexane diisocyanate (hexamethylene diisocyanate, HDI), 4-isocyanatomethyl-1,8-octane diisocyanate (triisocyanatononane, TIN), 4,4′-methylenebis(cyclohexyl isocyanate), 3,5,5-trimethyl-1-isocyanato-3-isocyanatomethylcyclohexane (isophorone diisocyanate, IPDI), 2,4- and/or 2,6-methylcyclohexyl diisocyanate (H₆TDI) as well as ω,ω′-diisocyanato-1,3-dimethylcyclohexane (H₆XDI), xylylene diisocyanate (XDI), 4,4′-diisocyanato-dicyclohexylmethane, tetramethylene diisocyanate, 2-methylpentamethylene diisocyanate, 2,2,4-trimethylhexamethylene diisocyanate (THDI), dodecamethylene diisocyanate, 1,4-diisocyanato-cyclohexane, 4,4′-diisocyanato-3,3′-dimethyl-dicyclohexylmethane, 4,4′-diisocyanatodicyclo-hexylpropane-(2,2), 3-isocyanatomethyl-1-methyl-1-isocyanatocyclohexane (MCI), 1,3-diiso-octylcyanato-4-methyl-cyclohexane, 1,3-diisocyanato-2-methyl-cyclohexane and α,α,α′,α′-tetra-methyl-m- or -p-xylylene diisocyanate (TMXDI), 2,4-/2,6-toluene diisocyanate (TDI), methylenediphenyl diisocyanate (MDI), naphthyl diisocyanate (NDI). Preference is given to the use of IPDI, HDI or TDI or MDI derivatives.

All or some of the above-mentioned organic aliphatic, cycloaliphatic or heterocyclic polyisocyanates can also be used in the form of their derivatives, such as, for example, urethanes, biurets, allophanates, uretdiones, isocyanurates and trimerisates and mixed forms of those derivatives.

Mixtures of a plurality of polyisocyanates can also be used in principle, but the use of only one polyisocyanate is preferred.

Suitable isocyanate-functional alkoxysilane compounds of the general formula (II) (component C) are in principle any alkoxysilane-group-containing monoisocyanates having a molecular weight of from 140 g/mol to 500 g/mol. Examples of such compounds are isocyanatomethyltrimethoxysilane, isocyanatomethyltriethoxysilane, (isocyanatomethyl)methyl-dimethoxysilane, (isocyanatomethyl)methyldiethoxysilane, 3-isocyanatopropyltrimethoxysilane, 3-isocyanatopropylmethyldimethoxysilane, 3-isocyanatopropyltriethoxysilane and 3-isocyanato-propylmethyldiethoxysilane. The use of 3-isocyanatopropyltrimethoxysilane is preferred.

It is also possible according to the invention to use isocyanate-functional silanes which have been prepared by reaction of a diisocyanate with an amino- or thio-silane, as are described in U.S. Pat. No. 4,146,585 or EP-A 1 136 495.

The invention further provides a process for the preparation of polymers modified with alkoxysilane groups according to the above description, in which a mixture of isocyanate-reactive compounds (component A) is first reacted with a polyisocyanate (component B) to give a prepolymer containing isocyanate-reactive hydrogen, which is subsequently masked by reaction with an isocyanate-functional alkoxysilane (component C).

For the synthesis of a prepolymer containing isocyanate-reactive hydrogen, an excess of component A is used, there preferably being chosen an NCO:Y¹—H ratio of from 1.0:1.3 to 1.0:3.0, particularly preferably from 1.0:1.5 to 1.0:2.0.

The urethanisation can be accelerated by catalysis. Urethanisation catalysts known per se to the person skilled in the art, such as organotin compounds or amine catalysts, are suitable for accelerating the NCO—OH reaction. Examples of organotin compounds which may be mentioned include: dibutyltin diacetate, dibutyltin dilaurate, dioctyltin dilaurate, dibutyltin bis-acetoacetonate and tin carboxylates such as, for example, tin octoate. The mentioned tin catalysts can optionally be used in combination with amine catalysts such as aminosilanes or 1,4-diazabicyclo[2.2.2]octane.

Dibutyltin dilaurate is particularly preferably used as the urethanisation catalyst.

In the process according to the invention, the catalyst component, where used, is employed in amounts of from 0.001 wt. % to 5.0 wt. %, preferably from 0.001 wt. % to 0.1 wt. % and particularly preferably from 0.005 wt. % to 0.05 wt. %, based on the solids content of the process product.

The urethanisation of components A and B is carried out at temperatures of from 20° C. to 200° C., preferably from 40° C. to 140° C. and particularly preferably from 60° C. to 120° C.

The reaction is continued until complete conversion of the isocyanate-reactive groups is achieved. The progress of the reaction is expediently monitored by checking the NCO content and is complete when the corresponding theoretical NCO content is reached and is constant. This can be monitored by means of suitable measuring devices fitted in the reaction vessel and/or by analysis of removed samples. Suitable methods are known to the person skilled in the art. They are, for example, viscosity measurements, measurements of the NCO content, of the refractive index, of the OH content, gas chromatography (GC), nuclear magnetic resonance spectroscopy (NMR), infrared spectroscopy (IR) and near-infrared spectroscopy (NIR). The NCO content of the mixture is preferably determined by titrimetry.

It is immaterial whether the process according to the invention is carried out continuously, for example in a static mixer, extruder or kneader, or discontinuously, for example in a stirred reactor.

The process according to the invention is preferably carried out in a stirred reactor.

The further reaction of the prepolymers containing isocyanate-reactive hydrogen with isocyanate-functional alkoxysilanes (component C) is carried out as described in EP-B 1 924 621 within a temperature range of from 20° C. to 200° C., preferably from 40° C. to 120° C. and particularly preferably from 60° C. to 100° C., the relative proportions generally being so chosen that an excess of NCO groups is used, which is taken up at the end with compounds reactive towards isocyanates or by allophanatisation.

The invention further provides adhesives, coatings or foams based on the polyurethane prepolymers according to the invention. The adhesives, coatings or foams crosslink under the action of atmospheric moisture via a silanol polycondensation. Preference is given to the use of the prepolymers according to the invention in adhesives, particularly preferably in adhesives that exhibit a tensile-shear strength according to DIN EN 14293 of at least 5 N/mm².

In order to produce such adhesives, coatings and foams, the polyurethane prepolymers containing alkoxysilane end groups according to the invention can be formulated by known processes together with conventional plasticisers, fillers, pigments, drying agents, additives, light stabilisers, antioxidants, thixotropic agents, catalysts, adhesion promoters and optionally further auxiliary substances and additives.

Typical adhesive and coating preparations according to the invention comprise, for example, from 10 wt. % to 100 wt. % of a polymer modified with alkoxysilane groups according to any one of claims 1 to 4 or of a mixture of two or more such polymers modified with alkoxysilane groups, up to 30 wt. % of a plasticiser or of a mixture of two or more plasticisers, up to 30 wt. % of a solvent or of a mixture of two or more solvents, up to 5 wt. % of a moisture stabiliser or of a mixture of two or more moisture stabilisers, up to 5 wt. % of a UV stabiliser or of a mixture of two or more UV stabilisers, up to 5 wt. % of a catalyst or of a mixture of two or more catalysts, and up to 80 wt. % of a filler or of a mixture of two or more fillers.

Examples of suitable fillers which may be mentioned include carbon black, precipitated silicas, pyrogenic silicas, mineral chalks and precipitated chalks. Examples of suitable plasticisers which may be mentioned include phthalic acid esters, adipic acid esters, alkylsulfonic acid esters of phenol, phosphoric acid esters and higher molecular weight polypropylene glycols.

Examples of thixotropic agents which may be mentioned include pyrogenic silicas, polyamides, hydrogenated castor oil secondary products and polyvinyl chloride.

Suitable catalysts for curing which can be used are any organometallic compounds and amine catalysts that are known to promote silane polycondensation. Particularly suitable organometallic compounds are in particular compounds of tin and titanium. Preferred tin compounds are, for example: dibutyltin diacetate, dibutyltin dilaurate, dioctyltin maleate and tin carboxylates such as, for example, tin(II) octoate or dibutyltin bis-acetoacetonate. The mentioned tin catalysts can optionally be used in combination with amine catalysts such as aminosilanes or 1,4-diazabicyclo[2.2.2]octane. Preferred titanium compounds are, for example, alkyl titanates, such as diisobutyl bis-acetoacetic acid ethyl ester titanate. For the use of amine catalysts alone there are suitable in particular those which have a particularly high base strength, such as amines having an amidine structure. Preferred amine catalysts are therefore, for example, 1,8-diazabicyclo[5.4.0]undec-7-ene or 1,5-diazabicyclo[4.3.0]non-5-ene.

There may be mentioned as drying agents in particular alkoxysilyl compounds, such as vinyl-trimethoxysilane, methyltrimethoxysilane, isobutyltrimethoxysilane, hexadecyltrimethoxysilane.

There are used as adhesion promoters the known functional silanes, such as, for example, amino-silanes of the above-mentioned type but also N-aminoethyl-3-aminopropyl-trimethoxy- and/or N-aminoethyl-3-aminopropyl-methyl-dimethoxysilane, epoxysilanes and/or mercaptosilanes.

### EXAMPLES

The examples which follow illustrate the present invention without limiting it.

Unless indicated otherwise, all percentages are by weight.

The NCO contents, in %, were determined by back-titration with 0.1 mol/1 hydrochloric acid after reaction with butylamine, on the basis of DIN EN ISO 11909.

The viscosity measurements were carried out in accordance with ISO/DIS 3219:1990 at a constant temperature of 23° C. and a constant shear rate of 250/sec by means of a plate/cone rotary viscometer of the Physica MCR type (Anton Paar Germany GmbH, Ostfildern, DE) using measuring cone CP 25-1 (25 mm diameter, 1° cone angle).

The ambient temperature of 23° C. prevailing at the time of the tests is referred to as RT.

### Example 1 (According to the Invention)

In a 5-litre sulfonation beaker with a lid, a stirrer, a thermometer and a nitrogen through-flow, a mixture of 1428.3 g of polypropylene glycol having a hydroxyl number of 28 mg KOH/g and 198.4 g of tripolypropylene glycol having a hydroxyl number of 585 mg KOH/g was heated to 120° C. 141.4 g of hexamethylene diisocyanate (Desmodur® H, Bayer MaterialScience AG) were then added, and prepolymerisation was carried out until no further NCO content was detectable by titrimetry. Then, at 120° C., 231.9 g of 3-isocyanatopropyltrimethoxysilane were added, and stirring was carried out until the theoretical NCO content of 0.05% was reached. The excess NCO was taken up by addition of methanol. The resulting polyurethane prepolymer having alkoxysilane end groups had a viscosity of 98,100 mPas (23° C.) and a number-average molecular weight of 3500 g/mol.

### Comparison Example 1

In a 1-litre sulfonation beaker with a lid, a stirrer, a thermometer and a nitrogen through-flow, a mixture of 1758.8 g of polypropylene glycol having a hydroxyl number of 56 mg KOH/g was heated to 120° C. 87.0 g of hexamethylene diisocyanate (Desmodur® H, Bayer MaterialScience AG) were then added, and prepolymerisation was carried out until no further NCO content was detectable by titrimetry. Then, at 120° C., 154.2 g of 3-isocyanatopropyltrimethoxysilane were added, and stirring was carried out until the theoretical NCO content of 0.05% was reached. The excess NCO was taken up by addition of methanol. The resulting polyurethane prepolymer having alkoxysilane end groups had a viscosity of 56,500 mPas (23° C.) and a number-average molecular weight of 3100 g/mol.

### Determination of the Skin Forming Time

By means of a knife (200 μm), a film is applied to a glass plate which has previously been cleaned with ethyl acetate, and the plate is immediately inserted into the Drying Recorder. The needle is loaded with 10 g and moves a distance of 35 cm over a period of 24 hours.

The Drying Recorder is located in a climatic chamber at 23° C. and 50% relative humidity.

The skin forming time is given as the time at which the permanent trace of the needle disappears from the film.

### Application Examples

In order to evaluate the application-related properties of the various polymers, they were processed in the following formulation:

| | Amount used |
|---|---|
| | in wt. % |
| Polymer | 46.06 |
| Filler (Socal ® U₁S₂) | 49.75 |
| Drying agent (Dynasylan ® VTMO) | 2.76 |
| Adhesion promoter (Dynasylan ® 1146) | 1.38 |
| Catalyst (Lupragen ® N700) | 0.05 |

In order to prepare the formulation, the filler (Socal® U1S2; Solvay GmbH) and the drying agent (Dynasylan® VTMO; Evonik AG, Germany) are added to the polymer as binder and mixed at 3000 rpm in a vacuum dissolver with a wall scraper. The adhesion promoter (Dynasylan® 1146; Evonik AG) is then added and stirred in at 1000 rpm in the course of 5 minutes. Lastly, the catalyst (Lupragen® N700; BASF SE, Germany) is stirred in at 1000 rpm and, finally, air is removed from the finished mixture in vacuo.

In order to measure the physical properties, both membranes having a thickness of 2 mm and samples for determining the tensile-shear strength are prepared. The tensile-shear strength is measured using test specimens of oak, which are stored for 7 days at 23° C./50% relative humidity, then for 20 days at 40° C. and subsequently for one day at 23° C./50% relative humidity.

The hardness of the films is measured in accordance with DIN 53505 and the tensile-shear strength in accordance with DIN EN 14293.

The following table shows the results which were obtained:

| | Comp. 1 | Ex. 1 |
|---|---|---|
| Shore D hardness | 26 | 37 |
| Tensile-shear strength [N/mm²] | 3.1 | 7.3 |
| Skin forming time [min] | 60 | 50 |

1-10. (canceled)

11. A polymer modified with alkoxysilane groups, obtained by reacting
a) a prepolymer comprising isocyanate-reactive hydrogen, which comprises structural units of formula (I) 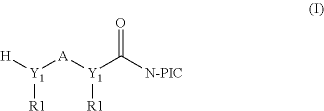
wherein
PIC is a radical of a polyisocyanate (B) reduced by the isocyanate groups;
Y¹ is nitrogen, oxygen or sulfur;
R¹ is either a free electron pair or hydrogen or any desired organic radical;
A is a radical, reduced by the isocyanate-reactive groups, of an isocyanate-reactive polymer and low molecular weight, multifunctional isocyanate-reactive compounds, which comprises low molecular weight, multifunctional isocyanate-reactive compounds (A1), which are linked together in any desired sequence via the structural element of the formula
—Y²—(C═O)—NH—PIC—NH—(C═O)—Y¹(R¹)—,
wherein Y¹ and Y² independently of one another are nitrogen, oxygen or sulfur, derived from the polyisocyanates B, and polyether polyols, polyester polyols, polycarbonate polyols or polytetrahydrofuran polyols (A2), wherein all or some of the terminal groups of those substructures can also be the corresponding thio compounds or amine derivatives,
wherein
from 1 to 40 weight % are substructures A1 having a mean molecular weight (Mn) of less than 500 g/mol and
from 60 to 99 weight % are substructures A2 having a mean molecular weight (Mn) of more than 500 g/mol, and
wherein A overall has a mean functionality of from 2 to 6,
with
b) an isocyanate-functional alkoxysilane compound (component C) of the general formula (II): 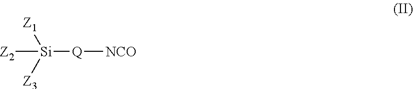
wherein
Z¹, Z² and Z³
are, identically or differently, C₁-C₈-alkoxy or C₁-C₈-alkyl radicals, which are optionally bridged, but wherein at least one C₁-C₈-alkoxy radical must be present on each Si atom, and
Q
is a difunctional linear or branched organic radical, preferably an alkylene radical having from 1 to 8 carbon atoms.

12. The polymer modified with alkoxysilane groups of claim 11, wherein said polymer has a number-average molecular weight of less than 5000 g/mol.

13. The polymer modified with alkoxysilane groups of claim 11, wherein said polymer has a number-average molecular weight of less than 4000 g/mol.

14. The polymer modified with alkoxysilane groups of claim 11, wherein said polymer has a viscosity of less than 700 Pas at 23° C.

15. A process for preparing the polymer modified with alkoxysilane groups of claim 11, wherein a mixture of isocyanate-reactive compounds (according to definition A with isocyanate-reactive groups present) is first reacted with a deficiency of polyisocyanate (component B) to give a prepolymer containing isocyanate-reactive hydrogen, which is subsequently masked by reaction with an isocyanate-functional alkoxysilane compound (component C).

16. The process of claim 15, wherein a deficiency of polyisocyanate in a ratio NCO to Y1-H of from 1.0:1.3 to 1.0:3.0 is used for the synthesis of the prepolymer containing isocyanate-reactive hydrogen.

17. The process of claim 15, wherein a deficiency of polyisocyanate in a ratio NCO to Y1-H of from 1.0:1.5 to 1.0:2.0 is used for the synthesis of the prepolymer containing isocyanate-reactive hydrogen.

18. The process of claim 15, wherein the reaction of the prepolymer containing isocyanate-reactive hydrogen with an isocyanate-functional alkoxysilane compound is carried out with a ratio NCO to Y1-H of from 0.8:1.0 to 1.5:1.0.

19. An adhesive, coating, or foams comprising the polymer modified with alkoxysilane groups of claim 11.

20. An adhesive and coating preparation comprising
from 10 weight % to 100 weigh t % of at least one polymer modified with alkoxysilane groups of claim 11;
from 0 weight % to 30 weight % of a plasticiser or of a mixture of two or more plasticisers;
from 0 weight % to 30 weight % of a solvent or of a mixture of two or more solvents;
from 0 weight % to 5 weight % of a moisture stabiliser or of a mixture of two or more moisture stabilisers;
from 0 weight % to 5 weight % of a UV stabiliser or of a mixture of two or more UV stabilisers;
from 0 weight % to 5 weight % of a catalyst or of a mixture of two or more catalysts;
from 0 weight % to 80 weigh t % of a filler or of a mixture of two or more fillers;
wherein the sum of the amounts of the components totals 100 weight %.

21. The polymer modified with alkoxysilane groups of claim 11, wherein Q is a difunctional linear or branched organic radical, preferably an alkylene radical having from 1 to 8 carbon atoms.

22. The polymer modified with alkoxysilane groups of claim 14, wherein said polymer has a viscosity of less than 500 Pas at 23° C.
